(19) United States
(12) Patent Application Publication
(10) Pub. No.: US 2012/0162075 A1
(43) Pub. Date: Jun. 28, 2012

(54) ULTRA THIN OPTICAL POINTING DEVICE AND PERSONAL PORTABLE DEVICE HAVING THE SAME

(75) Inventors: Keon Joon AHN, Seongnam-si (KR); Jae Dong KIM, Seoul (KR)

(73) Assignee: CRUCIAL TEC CO., LTD., Asan-si (KR)

(21) Appl. No.: 13/397,600

(22) Filed: Feb. 15, 2012

Related U.S. Application Data
(63) Continuation-in-part of application No. 11/994,975, filed on Jan. 7, 2008, now abandoned.

(30) Foreign Application Priority Data
Jul. 14, 2005 (KR) 10-2005-0063614

(51) Int. Cl. G06F 3/033

(52) U.S. Cl. 345/158

(57) ABSTRACT

An optical pointing device including a Printed Circuit Board (PCB); an infrared Light Emitting Diode (LED) provided on a side of the PCB; a cover plate for detecting motion of a subject, which is placed in an upper portion of the optical pointing device; an image forming system lens placed below the cover plate and configured to condense a light reflected from the subject; an optical image sensor for receiving a reflected image of the subject and detecting motion of the subject; and an optical coating unit placed on the optical image sensor. The cover plate and the optical coating unit are made of a material capable of passing a wavelength of infrared rays which cannot be perceived by a user's eye. A first cut off wavelength of the cover plate is shorter than a second cut off wavelength of the optical coating unit.

### CROSS REFERENCE TO PRIOR APPLICATIONS

This application claims the benefit of a prior-filed co-pending U.S. patent application Ser. No. 11/994,975 (filed on Jan. 7, 2008) under 35 U.S.C. §120, which is a National Stage Patent Application of International Patent Application No. PCT/KR2006/002736 (filed on Jul. 12, 2006) under 35 U.S.C. §371, which claims priority to Korean Patent Application No. 10-2005-0063614 (filed on Jul. 14, 2005), which are all hereby incorporated by reference in their entirety.

### BACKGROUND

The present invention relates, in general, to an ultra thin optical pointing device using an optical image sensor, and a personal portable device having the ultra thin optical pointing device and, more particularly, to an optical pointing device, which eliminates a user's discomfort caused by glare and prevents malfunction caused by ambient light in an ultra thin optical pointing device used in portable devices such as mobile phones, and to a personal portable device having the optical pointing device.

Currently, personal portable devices can be considered to be in a great turning point toward the improvement of a User Interface (UI). Such a current situation may be compared to the evolution of a computer system from a Disk Operating System (DOS) to a Windows environment.

In a conventional personal portable device, it has been difficult to use an optical mouse capable of freely performing a pointing operation as in the case of a computer, due to the size and portability thereof.

If an optical mouse generally used in computers is applied to a personal portable device, a user interface will be remarkably improved. Accordingly, a subminiature optical pointing device capable of being inserted into a personal portable device has recently been developed.

FIG. 1 is a diagram of an example of the optical pointing device, which shows a shape in which an optical mouse, used in a computer, is scaled down and inverted.

As shown in FIG. 1, an optical pointing device 100 that can be inserted into a personal portable device is constructed so that light emitted from a red Light Emitting Diode (LED) 101 through an illumination system 102 is directly radiated to a user's eye 110 when the user's finger, which is a subject, is not placed on a cover plate 103 for recognizing the finger.

In FIG. 1, reference numeral 105 denotes an image forming system lens, reference numeral 106 denotes a stop for blocking noise light, reference numeral 107 denotes an optical image sensor, reference numeral 108 denotes a Printed Circuit Board (PCB), and reference numeral 109 denotes a body tube.

If light 104 is directly radiated to the user's eye 110 in this way, the user may experience eye strain due to glare, etc., and may suffer a failure of eyesight when the eye is exposed to the light for a long period of time.

A light source used in an optical pointing device applied to a personal portable device, such as a mobile phone, is implemented using a red LED, generally used in a typical optical mouse, without modification. There is no special reason for utilizing a red LED as a light source, however, an optical pointing device basically uses the same image sensor chip as an optical mouse, so that the red LED, conventionally used in the optical mouse for a long period of time, is employed without change.

Since an ultra thin optical pointing device used in a mobile phone uses a finger as a subject, a light source radiates light toward a top surface without radiating light toward a bottom surface as in the case of an optical mouse used in a typical computer. That is, the optical pointing device is used in a state similar to a state in which a typical optical mouse is inverted.

Therefore, since light from the red LED is directly radiated to the user's eye, there is a problem in that the user's eyesight fails, or glare occurs, thus causing the user to feel discomfort.

The LED used in an optical pointing device for a mobile phone is a high luminance LED, so that blue, green and white LEDs, as well as the red LED, also cause the same problem.

Meanwhile, since a pointing device, having a shape in which the structure of an optical mouse is scaled down and inverted, has a limitation in thickness, there is a problem in that it is difficult to apply such a pointing device to a thin portable device. An optical waveguide pointing device having an ultra thin structure by changing an optical path to a horizontal direction in consideration of the above fact is disclosed in Korean Patent Application Nos. 10-2004-0113266, 10-2005-0000471, 10-2005-0005935, 10-2005-5936, 10-2005-5937, 10-2005-9356, and 10-2005-63614, which were filed by the present applicant.

As shown in FIG. 2, when a finger, a subject, is not placed on a cover plate 203 for recognizing the finger, an optical pointing device 200, having the above-described ultra thin optical waveguide structure, is constructed so that light emitted from a red LED 201 through an illumination system 202 is directly radiated to a user's eye 210.

Therefore, similar to FIG. 1, there may occur a problem in which a user easily experiences eye strain or undergoes a failure of eyesight due to glare, etc.

In FIG. 2, reference numerals 205 and 211 denote reflective surfaces, reference numeral 206 denotes a planoconvex lens, reference numerals 207 and 209 denote convex parts, reference numeral 208 denotes a stop for blocking noise light, reference numeral 212 denotes an output surface, reference numeral 213 denotes an optical image sensor, reference numeral 214 denotes a Printed Circuit Board (PCB), and reference numeral 216 denotes a main PCB.

In order to solve the above problem, if the light source is changed to an infrared light source, which cannot be perceived by the human eye, and the changed light source is applied, the above eyesight failure or glare can be prevented. That is, since an image sensor for an optical mouse is operated in a region of visible rays having wavelengths of 400 to 700 nm and a partial region of infrared rays having wavelengths of 700 to 900 nm, it is possible to change a light source to an infrared light source, which cannot be perceived by the human eye, and to apply the infrared light source.

However, in this case, it is only possible to prevent the user's eye from perceiving light radiated from a light source to the user's eye, but it is impossible to solve the problem of the malfunction of an optical image sensor caused by an external light source. That is, the malfunction of the optical image sensor caused by external ambient light cannot be prevented only by utilizing an infrared LED as a light source. This operation is described in detail with reference to FIGS. 3 and 4.

As shown in FIG. 3, visible light 304 originating from sunlight, or radiated from an external light source 310 influences an optical image sensor 307 after passing through a cover plate 303, which is a reading area, and an imaging forming system lens 305. Therefore, such a structure is the cause of malfunction of the optical image sensor 307.

Further, as shown in FIG. 4, visible light 404 originating from sunlight, or radiated from an external light source 410 influences an optical image sensor 413 after passing through a cover plate 403, which is a reading area, and through reflective surfaces 405 and 411, and a planoconvex lens 406. Such a structure is also the cause of the malfunction of the optical image sensor 413.

### SUMMARY

Accordingly, the present invention has been made keeping in mind the above problems occurring in the prior art, and an object of the present invention is to provide an ultra thin optical pointing device, which can minimize the malfunction of an optical image sensor caused by external ambient light while preventing a user from experiencing eye strain or undergoing a failure of eyesight due to glare, etc.

Another object of the present invention is to provide a lens module, which can be easily mounted in a personal portable device having an ultra thin optical pointing device.

In order to accomplish the above objects, the present invention is characterized in that a lens module implemented using an optical plastic material, having the characteristics of a band pass filter for passing only a wavelength band of infrared rays of 700 to 3,000 nm, is applied to an optical pointing device.

An optical pointing device according to a first embodiment of the present invention comprises a Printed Circuit Board (PCB); an infrared Light Emitting Diode (LED) provided on a side of a top surface of the PCB; a cover plate for detecting motion of a finger, which is a subject; an illumination system for transmitting light from the infrared LED to the cover plate placed in an upper portion of the optical pointing device; an image forming system lens placed below the cover plate and operated to condense light reflected from the subject; an optical image sensor for receiving a reflected image of the subject and detecting motion of the subject; and a body tube provided on a side portion over the PCB, wherein the illumination system, the cover plate and the image forming system lens are made of an optical plastic material capable of passing only a wavelength band of infrared rays which cannot be perceived by a user's eye.

Preferably, among the illumination system, the cover plate and the image forming system lens, both the cover plate and the image forming system lens may be made of an optical plastic material capable of passing only a wavelength band of infrared rays, and the illumination system may be made of an optical plastic material capable of passing both a wavelength band of infrared rays and a wavelength band of visible rays.

Preferably, among the illumination system, the cover plate and the image forming system lens, both the illumination system and the cover plate may be made of an optical plastic material capable of passing only a wavelength band of infrared rays, and the image forming system lens may be made of an optical plastic material capable of passing both a wavelength band of infrared rays and a wavelength band of visible rays.

An optical pointing device according to a second embodiment of the present invention comprises a Printed Circuit Board (PCB); an infrared Light Emitting Diode (LED) provided on a side of a top surface of the PCB; a cover plate for detecting motion of a finger, which is a subject; an illumination system for transmitting light from the infrared LED to the cover plate placed in an upper portion of the optical pointing device; at least one planoconvex lens for changing an optical path to a horizontal direction; and an optical image sensor for receiving a reflected image of the subject and detecting motion of the subject, wherein the illumination system, the cover plate and the planoconvex lens are made of an optical plastic material capable of passing only a wavelength band of infrared rays which can be perceived by a user's eye.

Preferably, among the illumination system, the cover plate and the planoconvex lens, both the cover plate and the planoconvex lens may be made of an optical plastic material capable of passing only a wavelength band of infrared rays, and the illumination system may be made of an optical plastic material capable of passing both a wavelength band of infrared rays and a wavelength band of visible rays.

Preferably, among the illumination system, the cover plate and the planoconvex lens, both the illumination system and the cover plate may be made of an optical plastic material capable of passing only a wavelength band of infrared rays, and the planoconvex lens may be made of an optical plastic material capable of passing both a wavelength band of infrared rays and a wavelength band of visible rays.

An optical pointing device according to a third embodiment of the present invention comprises a Printed Circuit Board (PCB); a body tube provided over the PCB; an infrared Light Emitting Diode (LED) placed in a side of an upper portion of the body tube to directly radiate light to a cover plate; a cover plate for detecting motion of a finger, which is a subject; an image forming system lens placed below the cover plate and operated to condense light reflected from the subject; and an optical image sensor for receiving a reflected image of the subject and detecting motion of the subject, wherein the cover plate and the image forming system lens are made of an optical plastic material capable of passing only a wavelength band of infrared rays which cannot be perceived by a user's eye.

Preferably, the cover plate may be made of an optical plastic material capable of passing only a wavelength band of infrared rays, and the image forming system lens may be made of an optical plastic material capable of passing both a wavelength band of infrared rays and a wavelength band of visible rays.

An optical pointing device according to a fourth embodiment of the present invention comprises a Printed Circuit Board (PCB); an infrared Light Emitting Diode (LED) placed on a top surface of the PCB to be spaced apart from the top surface of the PCB, and operated to directly radiate light to a cover plate; a cover plate for detecting motion of a finger, which is a subject; at least one planoconvex lens for changing an optical path to a horizontal direction; and an optical image sensor for receiving a reflected image of the subject and detecting motion of the subject, wherein the cover plate and the planoconvex lens are made of an optical plastic material capable of passing only a wavelength band of infrared rays which cannot be perceived by a user's eye.

Preferably, the cover plate may be made of an optical plastic material capable of passing only a wavelength band of infrared rays, and the planoconvex lens may be made of an optical plastic material capable of passing both a wavelength band of infrared rays and a. wavelength band of visible rays.

The optical pointing device of the present invention basically includes an infrared LED, and uses an optical plastic material capable of passing a wavelength region of infrared rays or visible rays. As the optical plastic material, optical plastic passing only a wavelength band of 700 to 3,000 nm, which is an infrared band, is used.

According to the optical pointing device of the present invention, infrared rays, having passed through an illumination system, are radiated to the cover plate, for passing only infrared rays, at a low radiation angle. In this case, if a finger, a subject, is placed on the cover plate, which is a reading area, light is transmitted to an optical image sensor through an image forming system lens, thus recognizing motion. In contrast, if a finger is not placed on the cover plate, light is output to the outside of the optical pointing device after passing through the cover plate.

Since light output to the outside in this way has a wavelength of infrared rays, the user cannot perceive the light. Therefore, the user does not experience eye strain or discomfort.

Further, if the cover plate, which is a reading area, is made of an optical plastic material, passing only a wavelength band of infrared rays, light cannot be incident into a lens module due to external ambient light, thus preventing the malfunction of the optical image sensor.

Further, if an optical plastic material, passing only a wavelength band of infrared rays, is also used for the image forming system lens, in addition to the cover plate, external noise light can be more efficiently blocked. Further, it does not matter whether the cover plate is made of an optical plastic material, passing only a wavelength band of infrared rays, and whether the image forming system lens is made of a typical optical plastic material, passing even a wavelength band of visible rays.

For the structure of the optical pointing device of the present invention, a shape, in which the structure of an optical mouse is scaled down and inverted, as shown in FIG. 5, can be used, or an optical waveguide planoconvex lens type, in which an optical path is changed from a vertical direction into a horizontal direction, as shown in FIG. 6, so as to reduce thickness to an ultra thin level, can be used. The optical waveguide planoconvex lens may have a symmetrical shape or an asymmetrical shape. Further, an image forming system lens can be inserted into the optical waveguide planoconvex lens in various forms;

Further, as shown in FIG. 7, the optical pointing device of the present invention may have a structure in which light emitted from an LED, a light source, is directly radiated to the cover plate without passing through an illumination system, in the shape in which the structure of an optical mouse is inverted. Alternatively, as shown in FIG. 8, the optical pointing device of the present invention may have a structure in which light emitted from an LED is directly radiated to the cover plate without passing through an illumination system in the optical waveguide planoconvex lens-type structure.

As described above, the optical pointing device and personal portable device having the optical pointing device according to the present invention is advantageous in that it can eliminate discomfort or eye strain, occurring when light emitted from an infrared LED is radiated to a user's eye.

Further, the present invention is advantageous in that it can minimize the malfunction of an optical image sensor that may occur when other external light is radiated. Further, the present invention is advantageous in that it enables an optical pointing device to be easily mounted in a small-sized portable device such as a mobile phone, thus further increasing the range of applications of the optical pointing device.

### DRAWINGS

FIG. 1 is a diagram showing an example in which LED light, emitted from an illumination system, is radiated to an eye in an optical pointing device having a shape in which an optical mouse is inverted;

FIG. 2 is a diagram showing an example in which LED light, emitted from an illumination system, is radiated to an eye in an optical waveguide planoconvex lens-type optical pointing device;

FIG. 3 is a diagram showing an example in which external light is radiated to an optical pointing device having a shape, in which an optical mouse is inverted, and influences the operation of an image sensor;

FIG. 4 is a diagram showing an example in which external light is radiated to an optical waveguide planoconvex lens-type optical pointing device and influences the operation of an image sensor;

FIG. 5 is a diagram showing an example in which infrared LED light, emitted from the illumination system of an optical pointing device according to a first embodiment of the present invention, is radiated to an eye;

FIG. 6 is a diagram showing an example in which infrared LED light, emitted from the illumination system of an optical waveguide planoconvex lens-type optical pointing device according to a second embodiment of the present invention, is radiated to an eye;

FIG. 7 is a diagram showing an example in which infrared LED light, emitted from the illumination system of an optical pointing device, according to a third embodiment of the present invention, is radiated to an eye;

FIG. 8 is a diagram showing an example in which infrared LED light, emitted from the illumination system of an optical waveguide planoconvex lens-type optical pointing device according to a fourth embodiment of the present invention, is radiated to an eye;

FIG. 9 is a diagram showing an operation of blocking external light using an optical plastic material for blocking light having a wavelength band, other than a wavelength band of infrared rays, when the external light is radiated to an optical pointing device having a shape in Which an optical mouse is inverted;

FIG. 10 is a diagram showing an operation of blocking external light using an optical plastic material for blocking light having a wavelength band, other than a wavelength band of infrared rays, when the external light is radiated to an optical waveguide planoconvex lens-type optical pointing device; and

FIG. 11 is a diagram showing a mobile phone to which an optical pointing device, passing only a wavelength band of infrared rays, is applied according to the present invention.

FIG. 12 is a diagram of a fifth embodiment of the present invention.

FIG. 13 is a graph depicting light transmittance in the fifth embodiment of the present invention.

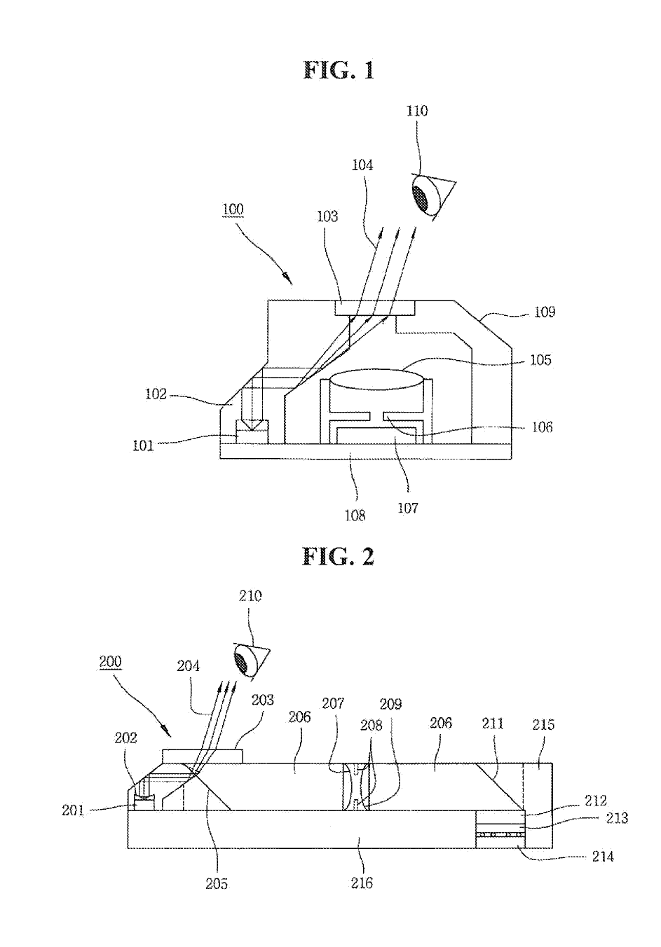

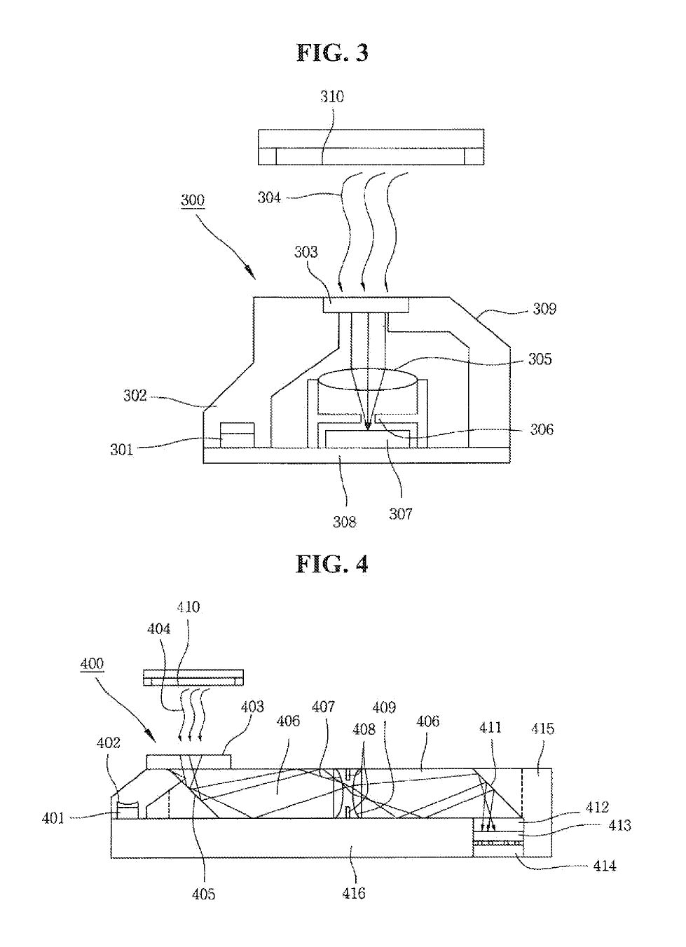

### DESCRIPTION

Hereinafter, embodiments of the present invention will be described in detail with reference to the attached drawings. Therefore, the protection scope of the present invention is not limited to the following embodiments.

### First Embodiment

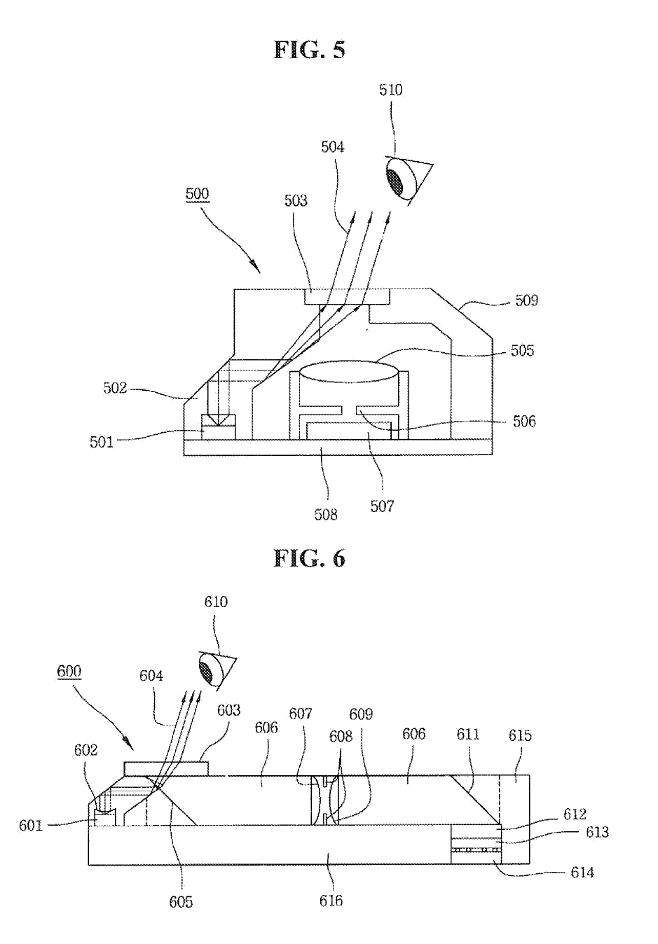

FIG. 5 is a diagram of a first embodiment of an optical pointing device according to the present invention, which shows an example in which a lens module, using an infrared LED and an optical plastic material for passing only a wavelength band of infrared rays, radiates infrared rays to a user's eye.

As shown in FIG. 5, the first embodiment of the present invention provides an optical pointing device 500 including a Printed Circuit Board (PCB) 508; an infrared LED 501 provided on a side of the top surface of the PCB 508 a cover plate 503 for detecting the motion of a finger, which is a subject an illumination system 502 for transmitting light from the infrared LED 501 to the cover plate 503 placed in an upper portion of the optical pointing device an image forming system lens 505 placed below the cover plate 503 and operated to condense light reflected from the subject an optical image sensor 507 for receiving the reflected image of the subject and detecting the motion of the subject and a body tube 509 provided on a side portion over the PCB 508, wherein the illumination system 502, the cover plate 503 and the image forming system lens 505 are made of an optical plastic material capable of passing only a wavelength band of infrared rays which cannot be perceived by the user's eye.

In a lens module composed of the illumination system 502, the cover plate 503 and the image forming system lens 505, the cover plate 503 and the image forming system lens 505 can be made of an optical plastic material capable of passing only a wavelength band of infrared rays, and the illumination system 502 can be made of an optical plastic material capable of passing both a wavelength band of infrared rays and a wavelength band of visible rays.

Further, in the lens module composed of the illumination system 502, the cover plate 503 and the image forming system lens 505, the illumination system 502 and the cover plate 503 can be made of an optical plastic material capable of passing only a wavelength band of infrared rays, and the image forming system lens 505 can be made of an optical plastic material capable of passing both a wavelength band of infrared rays and a wavelength band of visible rays.

According to the above structure, even if infrared rays are radiated to a user's eye 510, the user's eye 510 cannot perceive the wavelength band of infrared rays, and thus the user does not experience eye strain or discomfort caused by glare, etc.

### Second Embodiment

FIG. 6 is a diagram of a second embodiment of the present invention, which shows an example in which a lens module, using an infrared LED and an optical plastic material for passing only a wavelength band of infrared rays, radiates infrared rays to a user's eye in an optical waveguide planoconvex lens-type ultra thin optical pointing device which changes an optical path to a horizontal direction.

As shown in FIG. 6, the second embodiment of the present invention provides an optical pointing device 600 including a PCB 616; an infrared LED 601 provided on a side of the top surface of the PCB 616; a cover plate 603 for detecting the motion of a finger, which is a subject an illumination system 602 for transmitting light from the infrared LED 601 to the cover plate 603 placed in an upper portion of the optical pointing device at least one planoconvex lens 606 for changing an optical path to a horizontal direction and an optical image sensor 613 for receiving the reflected image of the subject and detecting the motion of the subject, wherein the illumination system 602, the cover plate 603 and the planoconvex lens 606 are made of an optical plastic material capable of passing only a wavelength band of infrared rays which cannot be perceived by the user's eye.

In a lens module composed of the illumination system 602, the cover plate 603, and the planoconvex lens 606, the cover plate 603 and the planoconvex lens 606 can be made of an optical plastic material capable of passing only a wavelength band of infrared rays, and the illumination system 602 can be made of an optical plastic material capable of passing both a wavelength band of infrared rays and a wavelength band of visible rays.

Further, in the lens module composed of the illumination system 602, the cover plate 603 and the planoconvex lens 606, the illumination system 602 and the cover plate 603 can be made of an optical plastic material capable of passing only a wavelength band of infrared rays, and the planoconvex lens 606 can be made of an optical plastic material capable of passing both a wavelength band of infrared rays and a wavelength band of visible rays.

The above structure is adopted, so that, even if infrared rays are radiated to a user's eye 610, the user's eye cannot perceive the wavelength band of infrared rays, and thus the user does not experience eye strain or discomfort caused by glare, etc.

### Third Embodiment

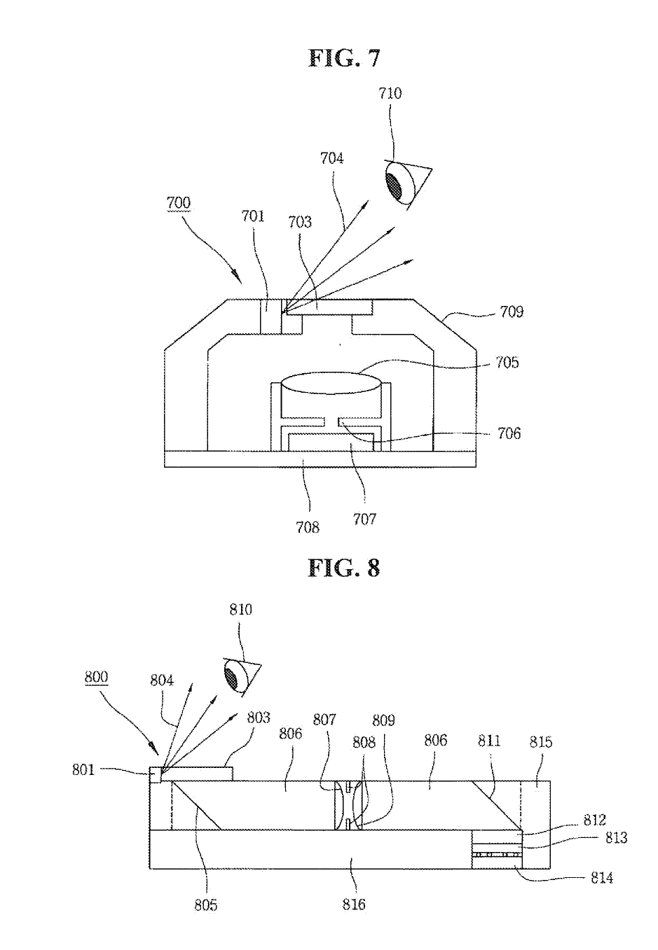

FIG. 7 is a diagram of a third embodiment of the present invention, which shows an example in which a lens module, using an optical plastic material for passing only a wavelength band of infrared rays, radiates infrared rays to a user's eye in an optical pointing device having a structure in which light from an infrared LED is directly radiated to a cover plate without passing through an illumination system.

As shown in FIG. 7, the third embodiment of the present invention provides an optical pointing device 700 including a PCB 708; a body tube 709 provided over the PCB 708 an infrared LED 701 placed in a side of an upper portion of the body tube 709; a cover plate 703 for detecting the motion of a finger, which is a subject an image forming system lens 705 placed below the cover plate 703 and operated to condense light reflected from the subject and an optical image sensor 707 for receiving the reflected image of the subject and detecting the motion of the subject, wherein the cover plate 703 and the image forming system lens 705 are made of an optical plastic material capable of passing only a wavelength band of infrared rays which cannot be perceived by the user's eye.

In a lens module composed of the cover plate 703 and the image forming system lens 705, the cover. plate 703 can be made of an optical .plastic material capable of passing only a wavelength band of infrared rays, and the image forming system lens 705 can be made of an optical plastic material capable of passing both, a wavelength band of infrared rays and a wavelength band of visible rays.

According to the above structure, even if infrared rays ate radiated to a user's eye 710, the user's eye 710 cannot perceive a wavelength band of infrared rays, and thus the user does not experience eye strain or discomfort caused by glare, etc.

### Fourth Embodiment

FIG. 8 is a diagram of a fourth embodiment of the present invention, which shows an example in which a lens module, using an optical plastic material for passing only a wavelength band of infrared rays, radiates infrared rays to a user's eye in an optical waveguide planoconvex lens-type optical pointing device in which light from an infrared LED is directly radiated to a cover plate without passing through an illumination system.

The fourth embodiment of the present invention provides an optical pointing device 800 including a PCB 816; an infrared LED 801 placed over the top surface of the PCB 816 to be spaced apart from the top surface of the PCB a cover plate 803 for detecting the motion of a finger, which is a subject at least one planoconvex lens 806 for changing an optical path to a horizontal direction; and an optical image sensor 813 for receiving the reflected image of the subject and detecting the motion of the subject, wherein the cover plate 803 and the planoconvex lens 806 are made of an optical plastic material capable of passing only a wavelength band of infrared rays which cannot be perceived by the user's eye.

In a lens module composed of the cover plate 803 and the planoconvex lens 806, the cover plate 803 can be made of an optical plastic material capable of passing only a wavelength band of infrared rays, and the planoconvex lens 806 can be made of an optical plastic material capable of passing both a wavelength band of infrared rays and a wavelength band of visible rays.

According to the above structure, even if infrared rays are radiated to a user's eye 810, the user's eye 810 cannot perceive the wavelength band of infrared rays, and thus the user does not experience eye strain or discomfort caused by glare, etc.

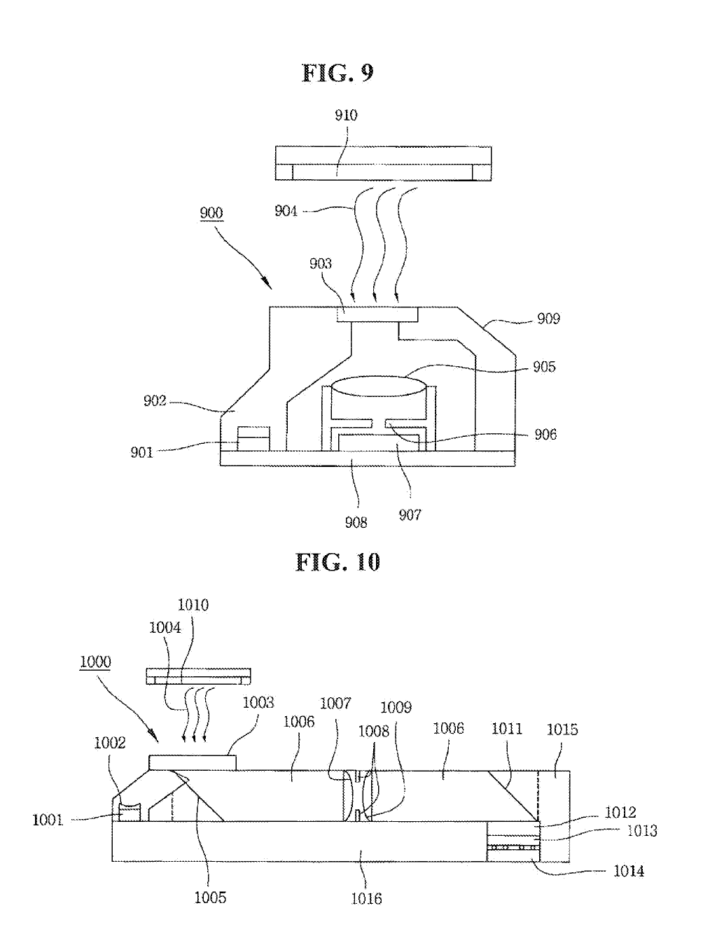

FIGS. 9 and 10 are diagrams showing situations in which visible light, originating from sunlight or radiated from other external light source, cannot pass through a cover plate, which is the reading area of an optical pointing device, and an image forming system lens.

FIG. 9 is a diagram showing an optical pointing device 900 having a shape in which an optical mouse is scaled down and inverted. Visible light 904 emitted from an external light source 910 is blocked by both a cover plate 903 and an image forming system lens 905, which are made of an optical plastic material for passing only a wavelength band of infrared rays, thus preventing the influence of visible light on an optical image sensor 907.

FIG. 10 is a diagram showing an optical waveguide-type optical pointing device 1000 for changing an optical path from a vertical direction to a horizontal direction so as to reduce thickness to an ultra thin level. Visible light 1004, emitted from an external light source 1010, is blocked by both a cover plate 1003 and a planoconvex lens 1006, which are made of an optical plastic material for passing only a wavelength band of infrared rays, thus preventing the influence of visible light on an optical image sensor 1013.

Generally, since an optical pointing device used in a personal portable device faces upwards, there is a high probability that an optical image sensor may cause malfunction due to various types of externally applied illumination.

The present invention applies a lens module, having the concept of a kind of band pass filter capable of passing only a wavelength band of infrared rays, to an optical pointing device, thus minimizing the malfunction of the optical image sensor caused by an external light source.

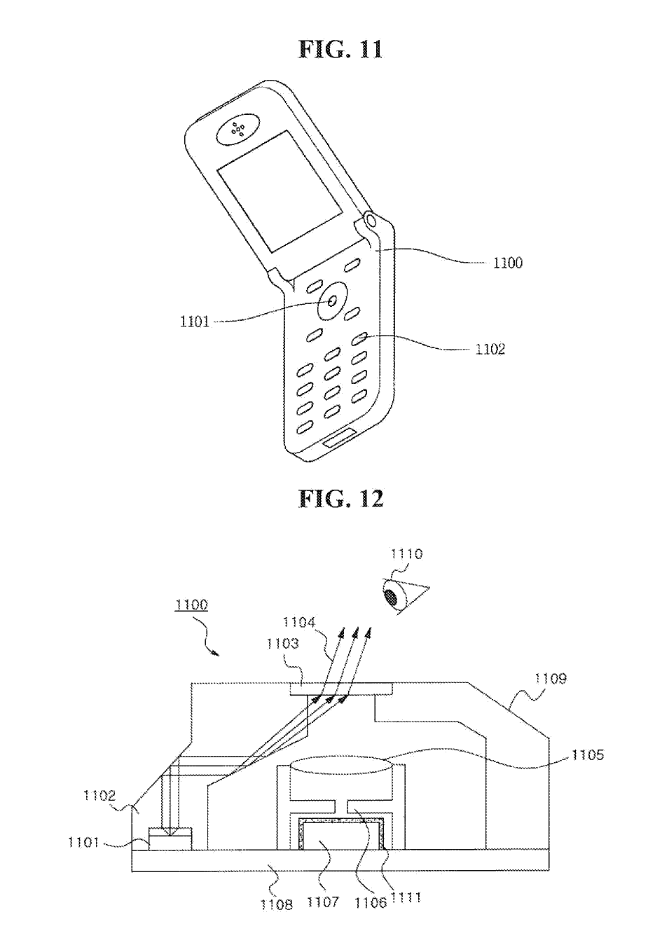

FIG. 11 is a diagram showing an example of a personal portable device 1100, in which an optical pointing device 1101 using the above-described optical plastic lens module is installed.

In the present specification, the term “personal portable device” commonly designates various portable electric and electronic devices such as a Personal Digital Assistant (PDA), a smart phone, a handheld PC, a mobile phone, or an MP3 player.

Further, the personal portable device includes a terminal which can be provided with a communication module, such as a Code. Division Multiple Access (CDMA) module, a Bluetooth module, an infrared communication module, or wired/wireless Local Area Network (LAN) card, and in which a microprocessor for performing a multimedia player function can be installed to have a predetermined computation capability.

### Fifth Embodiment

FIG. 12 is a diagram of a fifth embodiment of the present invention.

As shown in FIG. 12, the fifth embodiment of the present invention provides an optical pointing device 1100, which includes a cover plate 1103, a printed circuit board (PCB) 1108; an infrared LED 1101, an illumination system 1102, an image forming system lens 1105, an optical image sensor 1107, and a body tube 1109. In this embodiment, the elements having the same functions as those of the first to third embodiments are referred to by the same terms. In particular, the cover plate 1103 may be made of an optical plastic material which allows transmission of the infrared wavelength band which is invisible light.

The optical pointing device according to the fifth embodiment further includes an optical coating unit 1111 formed near the optical image sensor 1107. The optical coating unit 1111 may be made of an optical material which allows transmission of invisible light in the infrared wavelength band therethrough.

According to the fifth embodiment, both the cover plate 1103 and the optical coating unit 1111 may be made of a material which allows transmission of light in the infrared wavelength band therethrough. In some embodiments, the cover plate 1103 and the optical coating unit 1111 may have different light transmittances.

For example, assuming that a light source of the infrared LED 1101 has a center wavelength of 850 nm, the cover plate 1103 and the optical coating unit 1111 may have a cutoff wavelength in the range of about 650 nm-800 nm.

In the fifth embodiment of the present invention, the cover plate 1103 is formed to have a shorter cutoff wavelength than the cutoff wavelength of the optical coating unit 1111. For example, the cover plate 1103 may be formed to have a cutoff wavelength of 680 nm and the optical coating unit 1111 may be formed to have a cutoff wavelength of 780 nm.

When the cutoff wavelength of the cover plate 1103 is set to be shorter than the cutoff wavelength of the optical coating unit 1111, it is possible to allow light (infrared light) emitted from the Infrared LED 1101 to pass through the cover plate 1103 as much as possible. Since light passed through the cover plate 1103 is reflected by a subject such as a finger, light can be reflected as much as possible towards the optical image sensor 1107.

On the contrary, when the cutoff wavelength of the optical coating unit 1111 is set to be longer than the cutoff wavelength of the cover plate 1103, it is possible to prevent stray external infrared light from being introduced into the reflected light traveling towards the optical image sensor 1107. In other words, it is possible to allow light introduced into the optical image sensor 1107 to have wavelengths adjacent to the center wavelength of a light source of the IR LED by reducing external noise while securing a sufficient amount of reflected light from a subject.

According to the fifth embodiment, the optical pointing device 1100 may detect a subject with good sensitivity while minimizing failure caused by the external noise light.

In this embodiment, the cover plate 1103 is formed of an optical plastic material having a predetermined cutoff wavelength. For example, the cover plate 1103 may be formed of IR polycarbonate.

On the other hand, since an area at which movement of a finger is sensed by the optical image sensor 1107 is smaller than the overall area with which the finger comes into contact, the entirety of the cover plate 1103 is not necessarily formed of the optical plastic material. Thus, the cover plate 1103 may be provided with a light blocking unit which blocks external light from entering a sensing area. For this purpose, the cover plate 1103 may be manufactured by double injection-molding the optical plastic material and the light blocking unit at the same time. With the structure described above, it is possible to provide effective blocking of stray external light into the sensing area without adding a physical element or increasing the thickness thereof.

The optical coating unit 1111 may be formed by molding the optical image sensor 1107 and a wire connected thereto with a molding material. For example, the optical coating unit 1111 may be formed by molding the optical image sensor with an epoxy molding compound (EMC) which has a higher cutoff wavelength than that of the cover plate 1103.

In order to embody the optical coating unit 1111, an additional sub-PCB (not shown) connected to the PCB 1108 may be used. The image sensor 1107 is molded with the EMC in a state of being mounted on the sub-PCB. After mounting and molding, the sub-PCB may be easily mounted on the PCB 1108 by surface mount technology (SMT).

When the optical coating unit 1111 is formed of the EMC, the image sensor 1107 and the wire may be secured and protected from external contaminants and impact. Furthermore, since there is no need for an additional physical element, the thickness of the optical pointing device 1100 does not increase.

The optical coating unit 1111 may be embodied by a band pass filter which allows transmission of light in the infrared wavelength band therethrough. The optical coating unit 1111 has a longer cutoff wavelength in the band pass wavelength region than the center wavelength of the light source from the LED 1101. In this case, it is possible to prevent introduction of stray external light which has a longer wavelength than the center wavelength of the light source from the infrared LED 1101.

In some embodiments, the optical pointing device may further include a short wavelength pass filter (not shown) in addition to the optical coating unit 1111. For example, the optical coating unit 1111 may be formed of the EMC and the short wavelength pass filter may be coated on or added to another element. The short wavelength pass filter has a longer cutoff wavelength than the center wavelength of the light source from the LED 1101. In this case, it is possible to prevent introduction of stray external light which has a longer wavelength than the center wavelength of the light source from the LED 1101.

It should be understood that the features of the fifth embodiment may also be applied to the first to fourth embodiments described above without departing from the scope of the present invention.

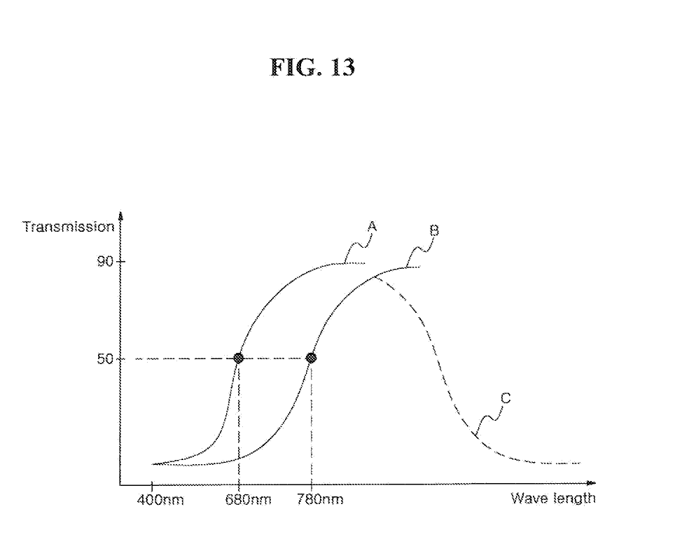

FIG. 13 is a graph depicting light transmittance in the fifth embodiment of the present invention.

Line A depicts light transmittance of the cover plate 1103. Lines B and C depict light transmittance of the optical coating unit 1111.

For example, assuming that the light source of the infrared LED 1101 has a center wavelength of 850 nm, the cover plate 1103 may have a cutoff wavelength in the range of about 680 nm and the optical coating unit 1111 may have a cutoff wavelength in the range of 780 nm, as shown in FIG. 13. Lines A and B of FIG. 13 depict such light transmittance properties of this embodiment. Line C depicts the case where the optical coating unit 1111 is embodied by the band pass filter or an additional short wavelength pass filter is present.

The optical pointing device according to the embodiments as described above may maintain good sensitivity while preventing stray external light, namely external noise light from being introduced into the optical pointing device.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

The present invention can be used for fields of an ultra thin optical pointing device using an optical image sensor, and a personal portable device having the optical pointing device.

What is claimed is:

1. An optical pointing device comprising:
a Printed Circuit Board (PCB);
an infrared Light Emitting Diode (LED) provided on a side of the PCB;
a cover plate for detecting motion of a subject, which is placed in an upper portion of the optical pointing device;
an image forming system lens placed below the cover plate and configured to condense a light reflected from the subject;
an optical image sensor for receiving a reflected image of the subject and detecting motion of the subject; and
an optical coating unit placed on the optical image sensor,
wherein the cover plate is made of an optical plastic material capable of passing a wavelength of infrared rays which cannot be perceived by a user's eye,
wherein the optical coating unit is made of a material capable of passing a wavelength of infrared rays which cannot be perceived by a user's eye, and
wherein a first cut off wavelength of the cover plate is shorter than a second cut off wavelength of the optical coating unit.

2. The optical pointing device according to claim 1, wherein the optical coating unit is configured to mold the optical image sensor by using an EMC (epoxy molding compound), whereby the optical image sensor and wires thereof are fixed and protected by the optical coating unit.

3. The optical pointing device according to claim 2, wherein the optical image sensor and the optical coating unit are mounted on an additional sub PCB.

4. The optical pointing device according to claim 3, the additional sub PCB is mounted on the PCB by using SMT (Surface Mount Technology).

5. The optical pointing device according to claim 1, wherein the optical coating unit is configured by a band pass filter having the second cut off wavelength and a third cut off wavelength, wherein the third cut off wavelength is longer than a central wavelength of light source of the infrared LED.

6. The optical pointing device according to claim 1 further comprising: a short wavelength pass filter having a fourth cut off wavelength, wherein the fourth cut off wavelength is longer than a central wavelength of light source of the infrared LED.

7. The optical pointing device according to claim 1, wherein the cover plate is configured by the optical plastic material and a light blocking unit by using a double injection molding method.

8. The optical pointing device according to claim 7, wherein the light blocking unit is placed outside a sensing area of the cover plate.
